(19) United States
(12) Patent Application Publication
(10) Pub. No.: US 2022/0410626 A1
(43) Pub. Date: Dec. 29, 2022

(54) PNEUMATIC TIRE

(71) Applicant: The Yokohama Rubber Co., LTD., Tokyo (JP)

(72) Inventors: Tatsuro SHINZAWA, Kanagawa (JP); Atsuhito NAKANO, Kanagawa (JP); Kenta HOMMA, Kanagawa (JP)

(21) Appl. No.: 17/756,291

(22) PCT Filed: Sep. 17, 2020
(86) PCT No.: PCT/JP2020/035365

§ 371 Date: May 20, 2022

(30) Foreign Application Priority Data
Nov. 25, 2019 (JP) 2019-212468

(51) Int. Cl. B60C 9/28; B60C 9/08

(52) U.S. Cl. CPC B60C 9/28; B60C 9/08; B60C 2009/0466

(57) ABSTRACT

In a pneumatic tire, an elongation at break (EB) of carcass cords constituting a carcass layer satisfies a condition of EB≥15%. A tread portion includes a pair of center main grooves each extending in a tire circumferential direction with a tire equator line interposed therebetween, and a center land portion defined by the pair of center main grooves. A ratio (Wc/Wb) of a width (Wc) of the center land portion to a width (Wb) of a widest belt within a belt layer in the tire width direction satisfies a condition of 0.10≤Wc/Wb≤0.20. An elongation at break (EB) of the carcass cords and the ratio (Wc/Wb) of the width (Wc) of the center land portion to the width (Wb) of the widest belt satisfy a condition of 350≤10×1/(Wc/Wb)+20×EB≤900.

### TECHNICAL FIELD

The present technology relates to a pneumatic tire including a carcass layer including organic fiber cords.

### BACKGROUND ART

Some pneumatic tires include carcass plies spanning between a pair of bead portions (see Japan Unexamined Patent Publication Nos. 2015-231772 and 2015-231773). One cause of failure of a pneumatic tire including carcass plies is damage (shock burst) inflicted on the tire due to a large shock to the tire during travel, leading to breakage of the carcass plies inside the tire.

Durability against such damage (shock burst resistance) may be determined by, for example, a plunger test. The plunger test is a test for measuring breaking energy generated when a tire is broken by pressing of a plunger having a predetermined size against a central portion of the tread on a tire surface. Thus, the plunger test can be used as an indicator of the breaking energy (breaking durability against projection input to the tread portion) when the pneumatic tire climbs over projections on an uneven road surface.

Rayon fiber cords formed from rayon materials having high rigidity have often been used as carcass cords constituting carcass plies for high-performance vehicle tires. However, in recent years, due to an increased maximum speed of the vehicle, a demanded weight reduction, and a demanded high grip, the gauge, altitude, and modulus of the rubber (cap tread rubber) of the ground contact portion of the tire have tended to decrease. This results in insufficient elongation at break of the carcass plies and reduced shock burst resistance. This leads to difficult provision of both shock burst resistance and traveling stability such as an increased maximum speed of the vehicle, a demanded weight reduction, and a demanded high grip in a compatible manner.

### SUMMARY

The present technology provides a pneumatic tire that provides both steering stability and shock burst resistance on dry road surfaces in a compatible manner by properly using organic fiber cords formed from organic fibers having rigidity comparable to that of rayon materials and having large elongation at break.

A pneumatic tire according to the present technology includes: a tread portion in which a pair of center main grooves each extending in a tire circumferential direction with a tire equator line interposed between the pair of center main grooves and a center land portion defined by the pair of center main grooves are formed; a pair of sidewall portions respectively disposed on both sides of the tread portion; a pair of bead portions each disposed on an inner side in a tire radial direction of the pair of sidewall portions; a carcass 10 layer that extends from the tread portion to reach the pair of bead portions via each of the pair of sidewall portions and whose end portions are turned back on an outer side in a tire width direction at each of the pair of bead portions; and a belt layer disposed on an outer side in the tire radial direction of the carcass layer. Carcass cords constituting the carcass layer has an elongation at break EB satisfying a condition of EB≥15%. A ratio Wc/Wb of a width Wc of the center land portion to a width Wb of a widest belt of the belt layer in the tire width direction satisfies a condition of 0.10≤Wc/Wb≤0.20. The elongation at break EB of the carcass cords and the ratio Wc/Wb of the width We of the center land portion to the width Wb of the widest belt satisfy a condition of 480≤10×1/(Wc/Wb)+20×EB≤900.

Additionally, in the tire width direction of the pneumatic tire described above, preferably, when the center land portion is located on the tire equator line, and the width We of the center land portion is divided by the tire equator line, a width on an outer side in a vehicle width direction is Wca and a width on an inner side in the vehicle width direction is Wcb, a condition of 0.8≤Wca/Wcb≤1.2 is satisfied.

Furthermore, in the pneumatic tire described above, preferably, when a width of a center main groove on an outer side in a vehicle width direction of the pair of center main grooves is Wg1 and a width of a center main groove on an inner side in the vehicle width direction of the pair of center main grooves is Wg2, a condition of 0.7≤Wg1/Wg2≤1.3 is satisfied.

Additionally, in the pneumatic tire described above, preferably, the carcass cords have, under a load of 1.0 cN/dtex, an intermediate elongation EM satisfying a condition of EM≤5.0%.

Additionally, in the pneumatic tire described above, preferably, the carcass cords have a fineness based on corrected weight CF satisfying a condition of 4000 dtex≤CF≤8000 dtex.

Additionally, in the pneumatic tire described above, preferably, the carcass cords have, after dip treatment, a twist coefficient CT satisfying a condition of CT≥2000 (T/dm)×dtex^{0.5}.

Additionally, in the pneumatic tire described above, preferably, the carcass cords have a nominal fineness NF satisfying a condition of 3500 dtex≤CF≤7000 dtex.

Additionally, in the pneumatic tire described above, preferably, the carcass cords have, under a load of 1.0 cN/dtex, an intermediate elongation EM satisfying a condition of 3.3%≤EM≤4.2%.

Furthermore, in the pneumatic tire described above, preferably, the carcass layer includes at least one textile carcass, and the material of the carcass cord is polyethylene terephthalate.

Additionally, in the pneumatic tire described above, preferably, the carcass cords have an elongation at break EB satisfying a condition of EB≥20%.

The pneumatic tire according to an embodiment of the present technology exerts the effect of allowing provision of both steering stability and shock burst resistance on dry road surfaces in a compatible manner.

### BRIEF DESCRIPTION OF DRAWINGS

FIG. 1 is a meridian cross-sectional view illustrating a main portion of a pneumatic tire according to an embodiment of the present technology.

FIG. 2 is a side view illustrating a vehicle on which a pneumatic tire according to an embodiment of the present technology is mounted.

FIG. 3 is a diagram of a vehicle on which a pneumatic tire according to an embodiment of the present technology is mounted as viewed from behind the vehicle.

FIG. 4 is a meridian cross-sectional view for explaining the relationship between a land portion and a circumferential main groove of a pneumatic tire according to an embodiment of the present technology.

FIG. 5A is a conceptual diagram for explaining the effect of change in the main groove position on the plunger test result.

FIG. 5B is a conceptual diagram for explaining the effect of change in the main groove position on the plunger test result.

FIG. 5C is a conceptual diagram for explaining the effect of change in the main groove position on the plunger test result.

FIG. 6 is an explanatory diagram illustrating a state in which a pneumatic tire according to the present embodiment treads on a projection on a road surface.

FIG. 7 is a schematic diagram illustrating a state in which a pneumatic tire according to the present embodiment treads on a projection on a road surface.

FIG. 8 is a schematic diagram illustrating a state in which a pneumatic tire with a relatively wide center land portion treads on a projection on a road surface.

### DETAILED DESCRIPTION

Pneumatic tires according to embodiments of the present technology will be described in detail below with reference to the drawings. However, the technology is not limited by the embodiment. Constituents of the following embodiments include elements that are essentially identical or that can be substituted or easily conceived of by one skilled in the art.

### Embodiments

### Pneumatic Tire

Hereinafter, “tire radial direction” refers to the direction orthogonal to a tire rotation axis RX corresponding to the rotation axis of a pneumatic tire 1. “Inner side in the tire radial direction” refers to the side toward the tire rotation axis RX in the tire radial direction. “Outer side in the tire radial direction” refers to the side away from the tire rotation axis RX in the tire radial direction. The term “tire circumferential direction” refers to a circumferential direction with the tire rotation axis RX as a center axis.

Additionally, a tire equatorial plane CL is a plane that is orthogonal to the tire rotation axis RX and that passes through the center of the tire width of the pneumatic tire 1. The position of the tire equatorial plane CL in the tire width direction aligns with the center line in the tire width direction corresponding to the center position of the pneumatic tire 1 in the tire width direction. “Tire equator line” refers to a line along the tire circumferential direction of the pneumatic tire 1 that lies on the tire equatorial plane CL.

Additionally, “tire width direction” refers to the direction parallel with the tire rotation axis RX. The term “inner side in the tire width direction” refers to the side toward the tire equatorial plane (tire equator line) CL in the tire width direction. The term “outer side in the tire width direction” refers to the side away from the tire equatorial plane CL in the tire width direction.

The tire width is the width in the tire width direction between portions located on the outermost sides in the tire width direction. In other words, the tire width is the distance between portions that are farthest from the tire equatorial plane CL in the tire width direction.

In the present embodiment, the pneumatic tire 1 is a tire for a passenger vehicle. The term “tire for a passenger vehicle” refers to a pneumatic tire defined in Chapter A of the JATMA YEAR BOOK (standards of The Japan Automobile Tyre Manufacturers Association. Inc.). In the present embodiment, a tire for a passenger vehicle will be described, but the pneumatic tire 1 may be a tire for a small truck defined in Chapter B. or may be a tire for a truck and a bus defined in Chapter C. Additionally, the pneumatic tire 1 may be a normal tire (summer tire) or a studless tire (winter tire).

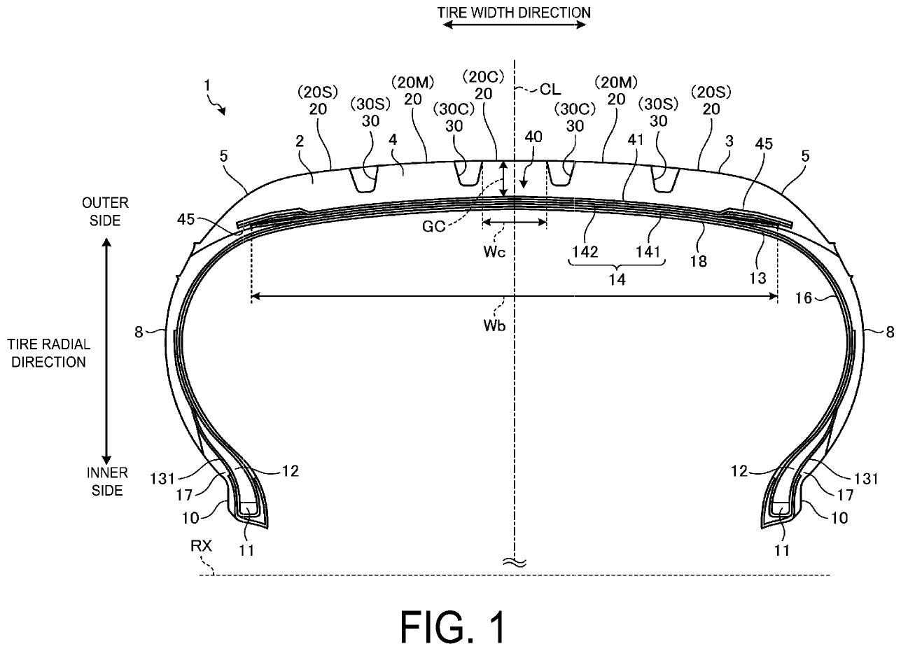

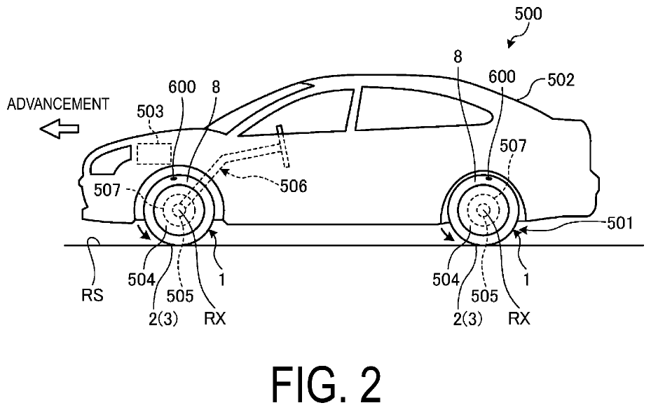

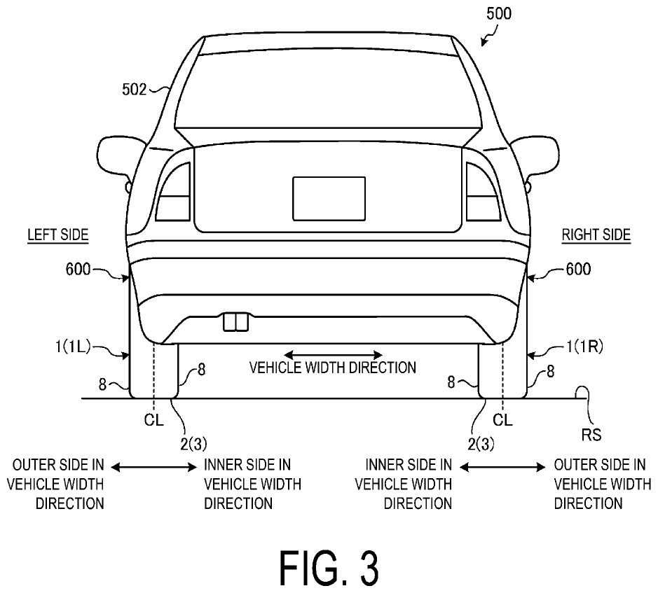

FIG. 1 is a meridian cross-sectional view illustrating a main portion of the pneumatic tire 1 according to a first embodiment. The term “meridian cross-section” refers to a cross section orthogonal to the tire equatorial plane CL. FIG. 2 is a side view illustrating a vehicle 500 on which the pneumatic tires 1 according to the present embodiment are mounted. FIG. 3 is a diagram of the vehicle 500 on which the pneumatic tires 1 according to the present embodiment are mounted as viewed from behind the vehicle 500. The pneumatic tire 1 according to the present embodiment mounted on a rim of a wheel 504 of the vehicle 500 illustrated in FIGS. 2 and 3 rotates around the tire rotation axis RX.

In the pneumatic tire 1 according to the present embodiment, as viewed in a tire meridian cross-section, a tread portion 2 extending in the tire circumferential direction and having an annular shape is disposed at the outermost portion in the tire radial direction. The tread portion 2 includes a tread rubber layer 4 formed of a rubber composition.

Additionally, a surface of the tread portion 2, that is, a portion that comes into contact with road surfaces during traveling of the vehicle 500 on which the pneumatic tires 1 are mounted is formed as a tread contact surface 3, and the tread contact surface 3 forms a portion of a contour of the pneumatic tire 1. In other words, cap tread rubber corresponds to the tread rubber layer 4 on the inner side of the tread contact surface 3 in the tire radial direction.

The tread contact surface 3 of the tread portion 2 is provided with a plurality of circumferential main grooves 30 extending in the tire circumferential direction and a plurality of lug grooves (not illustrated) extending in the tire width direction.

The term “circumferential main groove 30” refers to a groove extending in the tire circumferential direction and including a tread wear indicator (slip sign) inside. The tread wear indicator indicates the terminal stage of wear of the tread portion 2. The circumferential main groove 30 has a width of 4.0 mm or more and a depth of 5.0 mm or more.

The term “lug groove” refers to a groove at least partially extending in the tire width direction. The lug groove has a width of 1.5 mm or more and a depth of 4.0 mm or more. Note that the lug grooves may partly have a depth of less than 4.0 mm.

The circumferential main groove 30 may linearly extend in the tire circumferential direction, or may be provided in a wave shape or a zigzag shape amplifying in the tire width direction while extending in the tire circumferential direction. Additionally, the lug grooves may also extend linearly in the tire width direction, may be formed inclined in the tire circumferential direction while extending in the tire width direction, or may be formed bent or curved in the tire circumferential direction while extending in the tire width direction.

Additionally, in the tread contact surface 3 of the tread portion 2, a plurality of land portions 20 are defined by the circumferential main grooves 30 and the lug grooves.

In the present embodiment, four of the circumferential main grooves 30 are formed parallel in the tire width direction. Additionally, of two of the circumferential main grooves 30 disposed in one of a left region and a right region demarcated by the tire equatorial plane CL, the circumferential main groove 30 located on the outermost side in the tire width direction (outermost circumferential main groove) is defined as a shoulder main groove 30S, and the circumferential main groove 30 located on the innermost side in the tire width direction (innermost circumferential main groove) is defined as a center main groove 30C. The shoulder main groove 30S and the center main groove 30C are defined in each of the left and right regions demarcated by the tire equatorial plane CL.

Of the plurality of land portions 20 defined by the circumferential main grooves 30, the land portion 20 located further on the outer side than the shoulder main groove 30S in the tire width direction is defined as a shoulder land portion 20S, the land portion 20 between the shoulder main groove 30S and the center main groove 30C is defined as a middle land portion 20M, and the land portion 20 located further on the inner side of the center main groove 30C in the tire width direction is defined as a center land portion 20C. In other words, of the plurality of land portions 20 on the surface of the tread portion 2, the land portion 20 on the outermost side in the tire width direction is defined as the shoulder land portion 20S, and the land portion 20 on the innermost side in the tire width direction is defined as the center land portion 20C. The center land portion 20C includes a tire equatorial plane (tire equator line) CL in the tire width direction.

Shoulder portions 5 corresponding to shoulders of the tire are respectively positioned at both ends on outer sides of the tread portion 2 in the tire width direction (positioned further on the outer side than the shoulder land portion 20S), a pair of sidewall portions 8 are disposed on the inner side of the respective shoulder portion 5 in the tire radial direction. In other words, the pair of sidewall portions 8 are disposed on both sides in the tire width direction of the tread portion 2. The sidewall portions 8 thus formed form outermost exposed portions of the pneumatic tire 1 in the tire width direction.

Bead portions 10 are respectively disposed on the inner side of the pair of sidewall portion 8 in the tire radial direction. The bead portions 10 are respectively disposed at two locations on both sides of the tire equatorial plane CL. In other words, a pair of the bead portions 10 is disposed on both sides of the tire equatorial plane CL in the tire width direction.

The pair of bead portions 10 are each provided with a bead core 11, and a bead filler 12 is provided on the outer side of the bead core 11 in the tire radial direction. The bead core 11 is an annular member formed in an annular shape by bundling bead wires which are steel wires. The bead filler 12 is a rubber member disposed on the outer side of the bead core 11 in the tire radial direction.

A belt layer 14 is disposed in the tread portion 2. The belt layer 14 has a multilayer structure in which a plurality of belts 141 and 142 are layered. The belts 141, 142 constituting the belt layer 14 are formed by covering, with coating rubber, a plurality of belt cords made of steel or organic fibers, such as polyester, rayon, or nylon, and performing a rolling process thereon, and a belt angle defined as an inclination angle of the belt cords with respect to the tire circumferential direction is within a predetermined range (for example, of 20° or more and 55° or less).

Furthermore, the belt angles of the two layers of the belts 141, 142 differ from each another. Accordingly, the belt layer 14 is configured as a so-called crossply structure in which the two layers of the belts 141, 142 are layered with the inclination directions of the belt cords intersecting with each another. In other words, the two layers of the belts 141, 142 are provided as so-called a pair of cross belts in which the belt cords of the respective belts 141, 142 are disposed in mutually intersecting orientations.

A belt cover 40 is disposed on the outer side of the belt layer 14 in the tire radial direction. The belt cover 40 is disposed on the outer side of the belt layer 14 in the tire radial direction, covers the belt layer 14 in the tire circumferential direction, and is provided as a reinforcing layer that reinforces the belt layer 14.

The belt cover 40 has a width in the tire width direction that is greater than the width of the belt layer 14 in the tire width direction, and covers the belt layer 14 from the outer side in the tire radial direction. The belt cover 40 is disposed across the entire range in the tire width direction in which the belt layer 14 is disposed, and the belt cover 40 covers end portions of the belt layer 14 in the tire width direction. The tread rubber laver 4 of the tread portion 2 is disposed on the outer side of the belt cover 40 in the tread portion 2 in the tire radial direction.

Additionally, the belt cover 40 includes: a full cover portion 41 that is identical to the belt cover 40 in the width in the tire width direction; and edge cover portions 45 layered on the full cover portion 41 at two respective locations on both sides of the full cover portion 41 in the tire width direction.

Of the two edge cover portions 45, one edge cover portion 45 is located on the inner side of the full cover portion 41 in the tire radial direction, and the other edge cover portion 45 is located on the outer side of the full cover portion 41 in the tire radial direction.

A carcass layer 13 is continuously provided on the inner side of the belt layer 14 in the tire radial direction and on the tire equatorial plane CL side of the sidewall portion 8. In the present embodiment, the carcass layer 13 has a single layer structure made of one carcass ply or a multilayer structure made of a plurality of carcass plies being layered, and spans in a toroidal shape between the pair of bead portions 10 respectively disposed on both sides in the tire width direction, forming the backbone of the tire.

Specifically, the carcass layer 13 is disposed to span from one bead portion 10 to the other bead portion 10 among the pair of bead portions 10 located on both sides in the tire width direction and turns back toward the outer side in the tire width direction along the bead cores 11 at the bead portions 10 wrapping around the bead cores 11 and the bead fillers 12.

The bead filler 12 is a rubber member disposed in a space formed on the outer side of the bead core 11 in the tire radial direction when the carcass layer 13 is turned back at the bead core 11 of the bead portion 10 in this manner.

Additionally, in the bead portion 10, a rim cushion rubber 17 forming a contact surface of the bead portion 10 for a rim flange (not illustrated) is disposed on the inner side in the tire radial direction and on the outer side in the tire width direction of the bead core 11 and a turn-up portion 131 (turned back portion) of the carcass layer 13. The pair of rim cushion rubbers 17 extend from the inner side in the tire radial direction toward the outer side in the tire width direction of the left and right bead cores 11 and turn-up portions 131 of the carcass layer 13, and constitute rim fitting surfaces of the bead portions 10.

Moreover, the belt layer 14 is disposed on the outer side in the tire radial direction of a portion, located in the tread portion 2, of the carcass layer 13 spanning between the pair of bead portions 10 in this manner.

Additionally, the carcass ply of the carcass layer 13 is formed by covering, with coating rubber, a plurality of carcass cords made from organic fibers and performing a rolling process thereon. The plurality of carcass cords that form the carcass ply are disposed side by side with an angle in the tire circumferential direction, the angle with respect to the tire circumferential direction following a tire meridian direction.

In the present embodiment, the carcass layer 13 includes at least one carcass ply (textile carcass) using organic fiber cords (textile cords). The carcass layer 13 of the present embodiment includes the turn-up portion 131 on both end portions. The carcass layer 13 includes at least one textile carcass wound around the bead cores 11 respectively provided in the pair of bead portions 10.

The carcass cords forming the carcass ply of the carcass layer 13 are organic fiber cords including filament bundles of organic fibers intertwined together. The type of organic fibers constituting the carcass cords is not particularly limited, and for example, polyester fibers, nylon fibers, aramid fibers, or the like can be used. Poly ester fibers can be suitably used as the organic fibers. The polyester fibers that can be used include, for example, polyethylene terephthalate (PET), polybutylene terephthalate (PBT), and polybutylene naphthalate (PBN), and the like. As the polyester fibers, polyethylene terephthalate (PET) can be suitably used.

Additionally, an innerliner 16 is formed along the carcass layer 13 on the inner side of the carcass layer 13 or on the inner portion side of the carcass layer 13 in the pneumatic tire 1. The innerliner 16 is an air penetration preventing layer disposed in a tire cavity surface and covering the carcass layer 13, and the innerliner 16 suppresses oxidation due to exposure of the carcass layer 13 and additionally prevents leakage of air inside the tire. Additionally, the innerliner 16 includes, for example, a rubber composition containing butyl rubber as a main component, a thermoplastic resin, a thermoplastic elastomer composition containing an elastomer component blended with the thermoplastic resin, and the like. The innerliner 16 forms a tire inner surface 18 that is a surface on the inner side of the pneumatic tire 1.

### Vehicle Mounting Position

As illustrated in FIGS. 2 and 3, the vehicle 500 includes a driving apparatus 501 including the pneumatic tire 1, a vehicle body 502 supported by the driving apparatus 501, and an engine 503 for driving the driving apparatus 501.

The driving apparatus 501 includes the wheel 504 that supports the pneumatic tire 1, an axle 505 that supports the wheel 504, a steering apparatus 506 for changing the advancement direction of the driving apparatus 501, and a brake apparatus 507 for decelerating or stopping the driving apparatus 501.

The vehicle body 502 includes a driver cab occupied by a driver. Disposed in the driver cab are: the accelerator pedal used to adjust the output of the engine 503; the brake pedal used to actuate the brake apparatus 507; and the steering wheel used to operate the steering apparatus 506. The driver operates the accelerator pedal, the brake pedal, and the steering wheel. The driver performs operation to cause the vehicle 500 to travel.

The pneumatic tire 1 is mounted on a rim of the wheel 504 of the vehicle 500. Then, with the pneumatic tire 1 mounted on the rim, the inside of the pneumatic tire 1 is filled with air. By filling the inside of the pneumatic tire 1 with air, the pneumatic tire 1 is inflated.

The term “inflated state of the pneumatic tire 1” refers to the state in which the pneumatic tire 1 mounted on a specified rim is filled with air to a specified internal pressure.

“Specified rim” refers to a rim defined for each pneumatic tire 1 by standards for the pneumatic tire 1, and includes a “Standard Rim” defined by JATMA, a “Design Rim” defined by TRA (The Tire and Rim Association, Inc.), and a “Measuring Rim” defined by ETRTO (The European Tyre and Rim Technical Organisation).

“Specified internal pressure” refers to an air pressure defined for each pneumatic tire 1 by the standards for the pneumatic tire 1, and includes the “maximum air pressure” defined by JATMA, the maximum value in the table “TIRE LOAD LIMITS AT VARIOUS COLD INFLATION PRESSURES” defined by TRA, and the “INFLATION PRESSURE” defined by ETRTO. In JATMA, for tires for a passenger vehicle, the specified internal pressure is an air pressure of 180 kPa.

Additionally, “non-inflated state of the pneumatic tire 1” refers to a state in which the pneumatic tire 1 mounted on the specified rim is filled with no air. In the non-inflated state, the internal pressure of the pneumatic tire 1 is atmospheric pressure. In other words, in the non-inflated state, the internal pressure and the external pressure of the pneumatic tire 1 are substantially equal.

The pneumatic tire 1 mounted on the rim of the vehicle 500 rotates around the tire rotation axis RX and travels on a road surface RS. During traveling of the pneumatic tire 1, the tread contact surface 3 of the tread portion 2 comes into contact with the road surface RS.

In a loaded state of the pneumatic tire 1 being mounted on a specified rim, inflated to the specified internal pressure, and placed vertically on a flat surface, and a specified load being applied to the pneumatic tire 1, “tire ground contact edges” refer to end portions in the tire width direction of a portion (tread contact surface 3) of the tread portion 2 coming into contact with the ground. The shoulder land portions 20S of the tread portion 2 are land portions located on the outermost side in the tire width direction and on the tire ground contact edge.

“Specified load” refers to a load defined for each tire by the standards for the pneumatic tire 1, and includes the “maximum load capacity” defined by JATMA, the maximum value in the table “TIRE LOAD LIMITS AT VARIOUS COLD INFLATION PRESSURES” defined by TRA, and “LOAD CAPACITY” defined by ETRTO. However, when the pneumatic tire 1 is for a passenger vehicle, the load is assumed to correspond to 88% of the load.

The vehicle 500 is a four-wheeled vehicle. The driving apparatus 501 includes a left front wheel and a left rear wheel provided on the left side of the vehicle body 502 and a right front wheel and a right rear wheel provided on the right side of the vehicle body 502. The pneumatic tire 1 includes left pneumatic tires 1L mounted on the left side of the vehicle body 502 and right pneumatic tires 1R mounted on the right side of the vehicle body 502.

In the following description, “inner side in the vehicle width direction” refers as appropriate to a portion near the center of the vehicle 500 or a direction approaching the center of the vehicle 500 in the vehicle width direction of the vehicle 500. “Outer side in the vehicle width direction” refers as appropriate to a portion far from the center of the vehicle 500 or a direction leaving the center of the vehicle 500 in the vehicle width direction of the vehicle 500.

In the present embodiment, the mounting direction of the pneumatic tire 1 with respect to the vehicle 500 is designated. For example, in a case where the tread pattern of the tread portion 2 is an asymmetrical pattern, the mounting direction of the pneumatic tire 1 with respect to the vehicle 500 is designated. The left pneumatic tire 1L is mounted on the left side of the vehicle 500 such that one designated sidewall portion 8 of the pair of sidewall portions 8 faces the inner side in the vehicle width direction and the other sidewall portion 8 faces the outer side in the vehicle width direction. The right pneumatic tire 1R is mounted on the right side of the vehicle 500 such that one designated sidewall portion 8 of the pair of sidewall portions 8 faces the inner side in the vehicle width direction and the other sidewall portion 8 faces the outer side in the vehicle width direction.

In a case where a mounting direction of the pneumatic tire 1 with respect to the vehicle 500 is designated, the pneumatic tire 1 is provided with an indicator portion 600 indicating the designated mounting direction with respect to the vehicle 500. The indicator portion 600 is provided on at least one sidewall portion 8 of the pair of sidewall portions 8. The indicator portion 600 includes a serial symbol indicating the mounting direction with respect to the vehicle 500. The indicator portion 600 includes at least one of a mark, characters, a sign, and a pattern. An example of the indicator portion 600 indicating the mounting direction of the pneumatic tire 1 with respect to the vehicle 500 includes characters such as “OUTSIDE” or “INSIDE”. The user can recognize the mounting direction of the pneumatic tire 1 with respect to the vehicle 500 based on the indicator portion 600 provided on the sidewall portion 8. Based on the indicator portion 600, the left pneumatic tires 1L are mounted on the left side of the vehicle 500, and the right pneumatic tires 1R are mounted on the right side of the vehicle 500.

The pneumatic tire 1 of the present embodiment satisfies the following conditions. Specifically, elongation at break EB (%) of the carcass cords of the carcass layer 13 satisfies that EB is 15% or more. The elongation at break EB indicates the magnitude of elongation at break. The elongation at break EB of the carcass cords is physical properties sampled from the side portions of the pneumatic tire 1. Additionally, in the pneumatic tire 1, the ratio of a width We of the center land portion 20C of the tread contact surface 3 to a width Wb of the widest belt 141 in the tire width direction satisfies a condition of 0.10≤Wc/Wb≤0.20.

In the pneumatic tire satisfying the above-described conditions, the elongation at break EB of the carcass cords and the ratio Wc/Wb of the width Wc of the center land portion 20C of the tread contact surface 3 to the width Wb of the widest belt 141 satisfy the following conditions. In this regard, the elongation at break EB is a value expressed as a percentage, and in a case where the elongation at break is 15%, EB (%) in Formula (1) is 15.

480≤10×1/(Wc/Wb)+20×EB(%)≤900 (1)

The elongation at break EB of the carcass cords is preferably 20% or greater. More preferably, a condition of 0.13≤Wc/Wb≤0.17 may be satisfied.

Additionally, the elongation at break EB of the carcass cords and the ratio Wc/Wb of the width We of the center land portion 20C of the tread contact surface 3 to the width Wb of the widest belt 141 preferably satisfy 510≤10×1/(Wc/Wb)+20×EB (%)≤870.

In the pneumatic tire 1, the ratio Wc/Wb of the width We of the center land portion 20C to the width Wb of the widest belt 141 and the elongation at break EB of the carcass cords satisfy the above-described range, and the elongation at break EB of the carcass cords and the ratio Wc/Wb of the width Wb of the center land portion 20C of the tread contact surface 3 to the width Wb of the widest belt 141 satisfy Equation (1). Therefore, the pneumatic tire 1 can provide both steering stability on dry road surfaces and shock burst resistance in a compatible manner. Specifically, by setting the Wc/Wb to be within the above-mentioned range, localized deformation is alleviated in the cross-sectional view in the tire circumferential direction, and the shock burst resistance of the pneumatic tire 1 is improved. Moreover, it is possible to prevent the grip performance of the pneumatic tire 1 on dry road surfaces from degrading due to a too small Wc/Wb and prevent the steering stability from degrading. In addition, by setting the elongation at break EB of the carcass cords to be within the above-mentioned range, it is possible to suppress the steering stability from degrading while improving the shock burst resistance of the pneumatic tire 1.

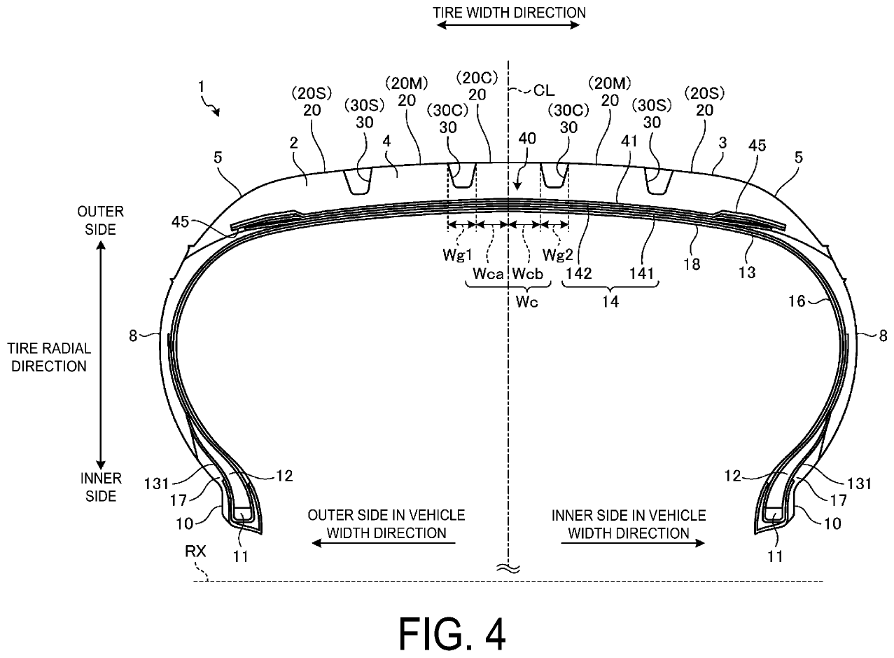

FIG. 4 is a meridian cross-sectional view for explaining the relationship between a land portion and a circumferential main groove of a pneumatic tire according to an embodiment of the present technology. As illustrated in FIG. 4, when the center land portion 20C is located on the tire equatorial plane (tire equator line) C L in the tire width direction, and the width We of the center land portion 20C is divided by the tire equatorial plane (tire equator line) CL, the width on the outer side in the vehicle width direction is defined as Wca and the width on the inner side in the vehicle width direction is defined as Wcb. That is, Wca+Wcb=Wc. Wca and Wcb may be left-right asymmetric with the tire equatorial plane (tire equator line) CL interposed therebetween.

In the pneumatic tire 1, Wca/Wcb preferably satisfies 0.8≤Wca/Wcb≤1.2. In the pneumatic tire 1, Wca/Wcb more preferably satisfies 0.9≤Wca/Wcb≤1.1, and further preferably Wca/Wcb=1.0. By setting the pneumatic tire 1 so as to satisfy the above-mentioned conditions, uniform force can be applied by the center land portion 20C at the time of a shock (when pressed by the plunger), so that the shock burst resistance can be further improved.

As illustrated in FIG. 4, the width of the center main groove 30C on the outer side in the vehicle width direction and the width of the center main groove 30C on the inner side in the vehicle width direction are defined as Wg1 and Wg2, respectively, for the two center main grooves 30C on the left and right sides of the tire equatorial plane (tire equator line) CL constituting the center land portion 20C in the tire width direction. Wg1 and Wg2 may be left-right asymmetric with the tire equatorial plane (tire equator line) CL interposed therebetween.

In the pneumatic tire 1. Wg1/Wg2 preferably satisfies 0.7≤Wg1/Wg2≤1.3, more preferably 0.9≤Wg1/Wg2≤1.1, and further more preferably Wg1/Wg2=1.0. By setting the widths so as to satisfy this condition, it is possible to apply uniform force to the center land portion 20C at the time of a shock and further improve the shock burst resistance.

Additionally, the carcass cords preferably have, under a load of 1.0 cN/dtex (nominal fineness), an intermediate elongation EM satisfying a condition of EM≤5.0%. Additionally, a nominal fineness NF of the carcass cords preferably satisfies a condition of 3500 dtex≤NF≤7000 dtex.

In particular, the intermediate elongation EM under a load of 1.0 cN/dtex load (nominal fineness) in the sidewall portion 8 of the carcass cord preferably satisfies that EM is 3.3% or more and 4.2% or less. The intermediate elongation under a load of 1.0 cN/dtex (nominal fineness) in the sidewall portion 8 of the carcass cord is more preferably set to be 3.5% or more and 4.0% or less.

“Intermediate elongation under a load of 1.0 cN/dtex” refers to the elongation percentage (%) of sample cords measured under a load of 1.0 cN/dtex, the sample cords corresponding to the carcass cords removed from the sidewall portions 8 of the pneumatic tire 1, the sample cords being subjected to a tensile test at a grip spacing of 250 mm and a tensile speed of 300±20 mm/minute in accordance with JIS (Japanese Industrial Standard) L1017 “Test Methods for Chemical Fibre Tire Cords”.

By reducing the intermediate elongation EM of the carcass cords while maintaining the elongation at break EB of the carcass cords, the steering stability on dry road surfaces can be improved with suppressing degradation of the shock burst resistance of the pneumatic tire 1.

Additionally, fineness based on corrected weight C F of the carcass cords after dip treatment preferably satisfies that CF is 4000 dtex or more and 8000 dtex or less. The fineness based on corrected weight after dip treatment more preferably satisfies that CF is 5000 dtex or more and 7000 dtex or less.

“Fineness based on corrected weight of the carcass cords after dip treatment” refers to the fineness measured after performing dip treatment on the carcass cords, and is not a value for the carcass cords themselves, but rather a value incorporating a dip liquid adhered to the carcass cords after dip treatment.

By setting the fineness based on corrected weight CF of the carcass cords after dip treatment to be within the range described above, the intermediate elongation EM of the carcass cords can be reduced with the elongation at break EB of the carcass cords maintained, allowing both steering stability on dry road surfaces and shock burst resistance of the pneumatic tire 1 to be provided in a compatible manner.

Additionally, in the pneumatic tire 1, the carcass cords preferably have, after dip treatment, a twist coefficient CT satisfying a condition of CT≥2000 (T/dm)×dtex^{0.5}. That is, it is preferable that the condition of CT≥2000 T/dm is satisfied and a condition of MF≥0.5 dtex is satisfied.

By setting the twist coefficient CT of the carcass cords after dip treatment to be within the range described above, the intermediate elongation EM of the carcass cords can be reduced with the elongation at break EB of the carcass cords maintained, allowing both steering stability on dry road surfaces and shock burst resistance of the pneumatic tire 1 can be provided in a compatible manner.

In addition, by reducing the intermediate elongation EM of the carcass cords with the elongation at break EB of the carcass cords maintained, the carcass cords are made easy to elongate and difficult to cut.

### Effect of Change in Main Groove Position on Plunger Test Results

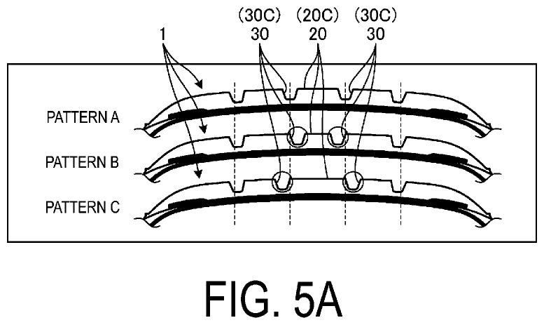

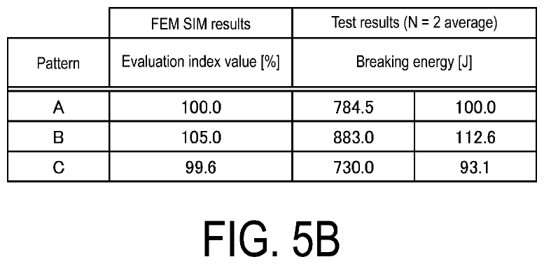

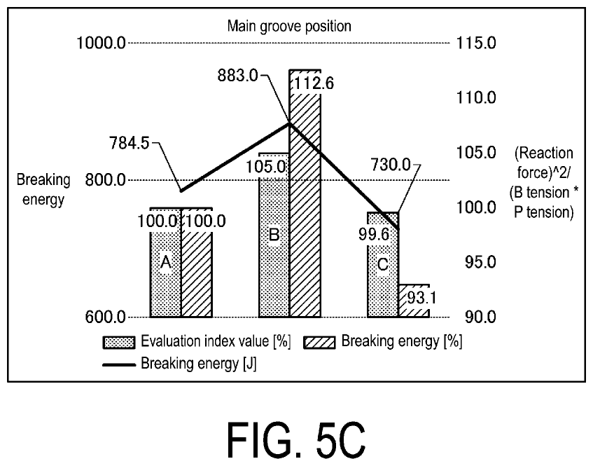

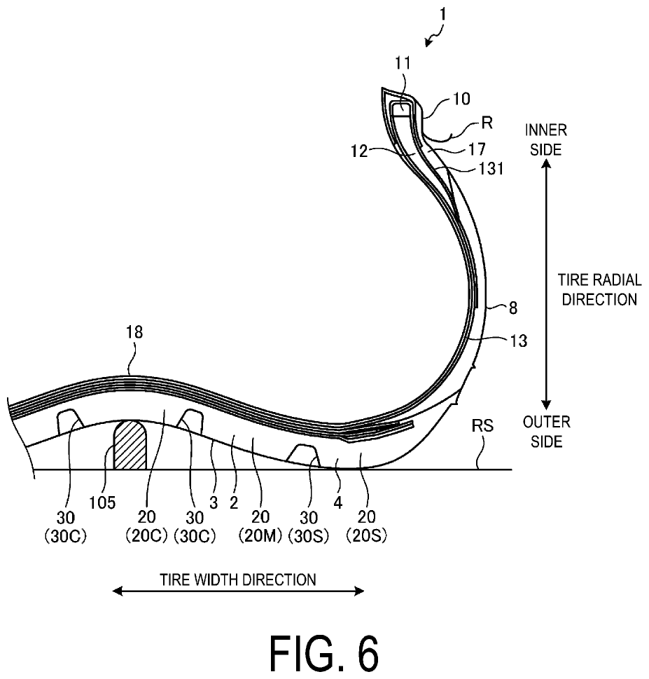

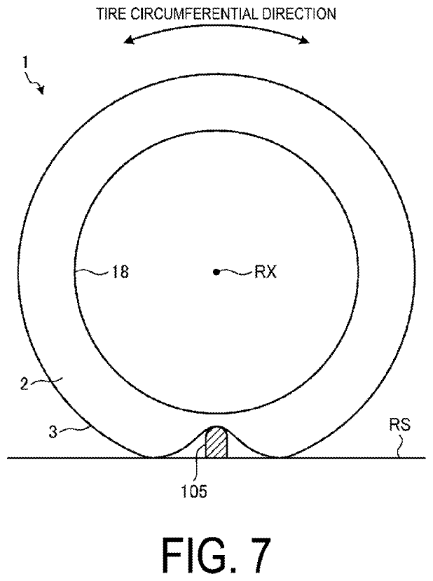

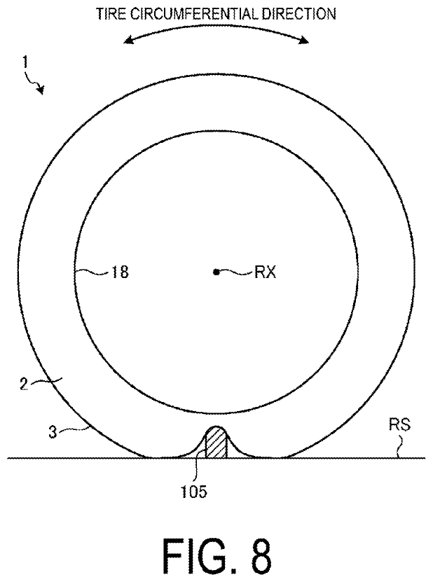

The effect on the plunger test results, of change in the position of the center main groove 30C of the pneumatic tire 1 according to the present embodiment will be described with reference to FIGS. 5 to 8. FIGS. 5A, 5B and 5C are conceptual diagrams for explaining the effect of change in the main groove position on the plunger test results. FIG. 6 is an explanatory diagram illustrating a state in which the pneumatic tire 1 according to the present embodiment treads on a projection on a road surface. FIG. 7 is a schematic diagram illustrating a state in which the pneumatic tire 1 according to the present embodiment treads on a projection on a road surface. FIG. 8 is a schematic diagram illustrating a state in which the pneumatic tire 1 in which the center land portion 20C has a relatively large width treads on a protrusion on a road surface. FIGS. 7 and 8 are schematic diagrams when the pneumatic tire 1 is viewed in a direction along the tire rotation axis RX.

As illustrated in FIG. 5A, the positions of the two center main grooves 30C on the left and right sides of the tire equatorial plane CL of the pneumatic tire 1 according to the present embodiment were changed, and the plunger test was performed for three patterns A. B. and C. In pattern A, the interval between the two center main grooves 30C was 30.4 mm. In pattern B, the interval between the two center main grooves 30C was 20.4 mm. In pattern C, the interval between the two center main grooves 30C was 40.4 mm. In other words, with reference to pattern A, the interval between the two center main grooves 30C in pattern B was changed to −10 mm, and the interval between the two center main grooves 30C in pattern C was changed to +10 mm.

Note that, in the structure, the interval between the two center main grooves 30C in the tire width direction represents the width We of the center land portion 20C.

As a result of performing the plunger test for three patterns A. B and C, as illustrated in FIGS. 5B and 5C, a better test result was obtained in pattern B than pattern A. and a sufficient test result was not obtained in pattern C as compared to pattern A.

That is, by moving the two center main grooves 30C toward the inner side in the tire width direction and reducing the width Wc of the center land portion 20C by 10 mm, the required breaking energy increased by about +99 J (about +13%). Similar trends were seen in the evaluation index of the finite element method simulation (FEM SIM).

In addition, in the center land portion 20C, the ratio Wc/Wb of the width W c of the center land portion 20C of the tread contact surface 3 to the width Wb of the widest belt 141 satisfies a condition of 0.10≤Wc/Wb≤0.20, and the elongation at break EB of the carcass cords and the ratio Wc/Wb of the width Wc of the center land portion 20C of the tread contact surface 3 to the width Wb of the widest belt 141 satisfy a condition of 350≤10×1/(Wc/Wb)+20×EB≤900. As a result, localized deformation of the tread portion 2 when treading on a projection 105 as a plunger can be alleviated, and shock burst resistance can be improved.

Specifically, by reducing the width Wc of the center land portion 20C by 10 mm, the tire strength is improved by approximately 100 J. Furthermore, by increasing the elongation at break EB of the carcass cords by 1%, the tire strength is improved by approximately 20 J.

Additionally, in a case where the projection 105 on the road surface RS is trodden on at or near the center land portion 20C of the tread portion 2, not only a predetermined range of the tread portion 2 in the tire width direction deflects toward the inner side in the tire radial direction according to the size of the projection 105 as illustrated in FIG. 6, but a predetermined range of the tread portion 2 in the tire circumferential direction also deflects toward the inner side in the tire radial direction as illustrated in FIG. 7. In this case, in the pneumatic tire 1 according to the first embodiment, the ratio Wc/Wb of the width We of the center land portion 20C of the tread contact surface 3 to the width Wb of the widest belt 141 satisfies a condition of 0.10≤Wc/Wb≤0.20, and thus the rigidity of the center land portion 20C is reduced. Therefore, a wide range of the tread portion 2 in the tire circumferential direction is bent toward the inner side in the tire radial direction.

That is, in a case where the ratio Wc/Wb of the width We of the center land portion 20C of the tread contact surface 3 to the width Wb of the widest belt 141 is Wc/Wb>0.20, the width of the center land portion 20C in the tire width direction is relatively large, and thus the rigidity of the center land portion 20C is relatively high. In a case where the projection 105 on the road surface RS is trodden on at or near the center land portion 20C of the tread portion 2 of the pneumatic tire 1 described above, the tread portion 2 is not easily bent over a wide range in the tire circumferential direction, and the tread portion 2 tends to bend in a narrow range in the tire circumferential direction, as illustrated in FIG. 8. That is, the tread portion 2 is locally greatly deformed. In this case, stress concentration is likely to occur in the tread portion 2, and reinforcing members such as the belt layer 14 and the carcass layer 13 are likely to be damaged, so that it is difficult to improve the shock burst resistance.

In contrast, in the pneumatic tire 1 according to the present embodiment, the ratio Wc/Wb of the width We of the center land portion 20C of the tread contact surface 3 to the width Wb of the widest belt 141 satisfies a condition of 0.10≤Wc/Wb≤0.20, so that the width of the center land portion 20C in the tire width direction is relatively small, and the rigidity of the center land portion 20C is relatively low. Thus, when the projection 105 on the road surface RS is trodden on at or near the center land portion 20C of the tread portion 2 of the pneumatic tire 1 according to the present embodiment, the tread portion 2 is easily bent over a wide range in the tire circumferential direction, as illustrated in FIG. 7. Accordingly, localized deformation of the tread portion 2 can be alleviated, and stress concentration of the tread portion 2 can be mitigated. Therefore, reinforcing members such as the belt layer 14 and the carcass layer 13 are not easily damaged, and shock burst resistance can be improved.

As described above, when the positions of the two center main grooves 30C on the left and right sides of the tire equatorial plane CL of the pneumatic tire 1 according to the present embodiment are changed, the bending of the pneumatic tire 1 when stepping on the projection 105 is also changed. When the width We of the center land portion 20C is small, the local deformation in the tire circumferential direction is alleviated. Thus, it can be inferred that it is superior in that the load applied to the reinforcing members such as the belt layer 14 and the carcass layer 13 is also alleviated.

### Examples

Tables 1 and 2 show results of performance tests of pneumatic tires according to the present embodiment. In the performance tests, a plurality of types of test tires having different conditions were evaluated for shock burst resistance and steering stability. In the performance tests, pneumatic tires (test tires) having a size of 265/35ZR20 were assembled on rims of 20×9.5 J, inflated to an air pressure of 200 kPa, and mounted on a test FF sedan passenger vehicle (total engine displacement of 1600 cc).

For evaluation of shock burst resistance, a plunger test was conducted in accordance with FMV S139 (Federal Motor Vehicle Safety Standards No. 139). Shock burst resistance is expressed as index values and evaluated, with Conventional Example being assigned as the reference (100). Larger values are more preferable.

For evaluation of steering stability, tests related to steering stability on dry road surfaces were conducted using a 3L class European vehicle (sedan). Note that in the tests related to steering stability on dry road surfaces, the test vehicle was driven on a test course of a dry road surface including a flat circuit at a speed of 60 km/h or more and 100 km/h or less. Then, sensory evaluation was conducted by a test driver for steering characteristics during lane change and cornering as well as stability during straight traveling. This is expressed as index values and evaluated, with Conventional Example being assigned as the reference (100). Larger values are more preferable.

In the pneumatic tire of Comparative Example 1, rayon fiber cords were used as the carcass cords constituting the carcass ply. On the other hand, in the pneumatic tires of Conventional Example Comparative Example 2, Comparative Example 3, and Examples 1 to 9. PET fiber cords formed of polyethylene terephthalate material having a large elongation at break as compared with rayon material were used as the carcass cords constituting the carcass ply. Table 3 is a comparison table of ray on fiber cords and PET fiber cords. As shown in Table 3, when the intermediate elongation of the carcass cord has the same conditions, the PET fiber cords have a high elongation at break and fineness based on corrected weight as compared to the rayon fiber cords. In addition, the rayon fiber cords are vulnerable to fatigue, and the number of twists needs to be increased to compensate it.

These pneumatic tires were evaluated for shock burst resistance and steering stability by an evaluation method described above, and the results are also shown in Tables 1 and 2.

TABLE 1-1

| | Conventional | Comparative | Comparative | Comparative |
|---|---|---|---|---|
| | Example | Example 1 | Example 2 | Example 3 |
| Type of organic fiber material | PET | Rayon | PET | PET |
| Elongation at break EB (%) | 45 | 10 | 20 | 20 |
| of carcass cords | | | | |
| Ratio Wc/Wb of center land | 0.25 | 0.25 | 0.13 | 0.05 |
| portion width to widest belt | | | | |
| width | | | | |
| 10 × 1/(Wc/Wb) + 20 × EB | 940 | 240 | 480 | 600 |
| Shock burst resistance | 100 | 70 | 110 | 120 |
| Steering stability | 100 | 120 | 100 | 80 |

TABLE 1-2

| | Example | Example | Example |
|---|---|---|---|
| | 1 | 2 | 3 |
| Type of organic fiber material | PET | PET | PET |
| Elongation at break EB (%) of | 25 | 25 | 30 |
| carcass cords | | | |
| Ratio Wc/Wb of center land | 0.15 | 0.11 | 0.15 |
| portion width to widest belt width | | | |
| 10 × 1/(Wc/Wb) + 20 × EB | 570 | 590 | 670 |
| Shock burst resistance | 110 | 115 | 132 |
| Steering stability | 110 | 100 | 112 |

TABLE 2-1

| | Example | Example | Example |
|---|---|---|---|
| | 1 | 2 | 3 |
| Type of organic fiber material | PET | PET | PET |
| Elongation at break EB (%) of | 25 | 25 | 30 |
| carcass cords | | | |
| Ratio Wc/Wb of center land | 0.15 | 0.11 | 0.15 |
| portion width to widest belt width | | | |
| 10 × 1 (Wc/Wb) + 20 × EB | 570 | 590 | 670 |
| Left and right center land portion | 1.4 | 1.1 | 1.0 |
| width ratio Wca/Wcb | | | |
| Left and right center main groove | 1.5 | 1.5 | 1.0 |
| width ratio Wg1/Wg2 | | | |
| Intermediate elongation EM (%) of | 6 | 6 | 4 |
| carcass cords | | | |
| Fineness based on corrected weight | 6400 | 9000 | 9000 |
| CF of carcass cords | | | |
| Twist coefficient CT of carcass cords | 1500 | 1500 | 2100 |
| Shock burst resistance | 110 | 115 | 132 |
| Steering stability | 110 | 100 | 112 |

TABLE 2-2

| | Example | Example | Example |
|---|---|---|---|
| | 4 | 5 | 6 |
| Type of organic fiber material | PET | PET | PET |
| Elongation at break EB (%) of | 25 | 25 | 30 |
| carcass cords | | | |
| Ratio Wc/Wb of center land | 0.11 | 0.15 | 0.15 |
| portion width to widest belt width | | | |
| 10 × 1(Wc/Wb) + 20 × EB | 570 | 570 | 670 |
| Left and right center land portion | 1.3 | 1.0 | 1.0 |
| width ratio Wca/Wcb | | | |
| Left and right center main groove | 1.5 | 1.0 | 1.0 |
| width ratio Wg1/Wg2 | | | |
| Intermediate elongation EM (%) of | 6 | 5 | 6 |
| carcass cords | | | |
| Fineness based on corrected weight | 9000 | 6400 | 9000 |
| CF of carcass cords | | | |
| Twist coefficient CT of carcass cords | 1500 | 1500 | 1500 |
| Shock burst resistance | 110 | 120 | 130 |
| Steering stability | 110 | 120 | 110 |

TABLE 2-3

| | Example | Example | Example |
|---|---|---|---|
| | 7 | 8 | 9 |
| Type of organic fiber material | PET | PET | PET |
| Elongation at break EB (%) of | 30 | 30 | 30 |
| carcass cords | | | |
| Ratio Wc/Wb of center land | 0.15 | 0.15 | 0.15 |
| portion width to widest belt width | | | |
| 10 × 1(Wc/Wb) + 20 × EB | 670 | 670 | 670 |
| Left and right center land portion | 1.0 | 1.0 | 1.0 |
| width ratio Wca/Wcb | | | |
| Left and right center main groove | 1.0 | 1.0 | 1.0 |
| width ratio Wg1/Wg2 | | | |
| Intermediate elongation EM (%) of | 4 | 4 | 4 |
| carcass cords | | | |
| Fineness based on corrected weight | 9000 | 6400 | 6400 |
| CF of carcass cords | | | |
| Twist coefficient CT of carcass cords | 1500 | 1500 | 2100 |
| Shock burst resistance | 130 | 130 | 132 |
| Steering stability | 110 | 110 | 112 |

TABLE 3

| Image of physical properties | Rayon | PET |
|---|---|---|
| Elongation at break EB (%) of carcass cords | About 13% | 22 to 28% |
| Intermediate elongation EM (%) of carcass | 2 to 3% | 2 to 3% |
| cords | | |
| Fineness based on corrected weight CF of | 6200 to 6300 | 6400 to 6500 |
| carcass cords | dtex | dtex |
| Twist coefficient CT of carcass cords | 2800 | 2100 |

As shown in Tables 1 and 2, it can be seen that the pneumatic tires described in Examples 1 to 9 can maintain high shock burst resistance and high steering stability as compared to the pneumatic tires of Conventional Example and Comparative Examples 1 to 3. In other words, at least under conditions identical to those for the pneumatic tires of Examples 1 to 9 lead to evaluation results equivalent to or higher than those in a case of using rayon fiber cords, even when using PET fiber cords. In addition, when the conditions are changed in a predetermined range, as in the pneumatic tires of Examples 1 to 9, more preferable evaluation results are obtained depending on the conditions.

1-6. (canceled)

7. A pneumatic tire comprising:
a tread portion in which a pair of center main grooves each extending in a tire circumferential direction with a tire equator line interposed between the pair of center main grooves and a center land portion defined by the pair of center main grooves are formed;
a pair of sidewall portions respectively disposed on both sides of the tread portion;
a pair of bead portions each disposed on an inner side in a tire radial direction of the pair of sidewall portions;
a carcass layer that extends from the tread portion to reach the pair of bead portions via each of the pair of sidewall portions and whose end portions are turned back on an outer side in a tire width direction at each of the pair of bead portions; and
a belt layer disposed on an outer side in the tire radial direction of the carcass layer;
carcass cords constituting the carcass layer having an elongation at break EB satisfying a condition of EB≥15%,
a ratio Wc/Wb of a width We of the center land portion to a width Wb of a widest belt of the belt layer in the tire width direction satisfying a condition of 0.10≤Wc/Wb≤0.20, and
the elongation at break EB of the carcass cords and the ratio Wc/Wb of the width We of the center land portion to the width Wb of the widest belt satisfying a condition of 480≤10×1/(Wc/Wb)+20×EB≤900.

8. The pneumatic tire according to claim 7, wherein, in the tire width direction, when the center land portion is located on the tire equator line, and the width We of the center land portion is divided by the tire equator line, a width on an outer side in a vehicle width direction is Wca and a width on an inner side in the vehicle width direction is Wcb, a condition of 0.8≤Wca/Wcb≤1.2 is satisfied.

9. The pneumatic tire according to claim 7, wherein, when a width of a center main groove on an outer side in a vehicle width direction of the pair of center main grooves is Wg1 and a width of a center main groove on an inner side in the vehicle width direction of the pair of center main grooves is Wg2, a condition of 0.7≤Wg1/Wg2≤1.3 is satisfied.

10. The pneumatic tire according to claim 7, wherein the carcass cords have, under a load of 1.0 cN/dtex, an intermediate elongation EM satisfying a condition of EM≤5.0%.

11. The pneumatic tire according to claim 7, wherein the carcass cords have a fineness based on corrected weight CF satisfying a condition of 4000 dtex≤CF≤8000 dtex.

12. The pneumatic tire according to claim 7, wherein the carcass cords have, after dip treatment, a twist coefficient CT satisfying a condition of CT≥2000 (T/dm)×dtex^{0.5}.

13. The pneumatic tire according to claim 8, wherein, when a width of a center main groove on an outer side in a vehicle width direction of the pair of center main grooves is Wg1 and a width of a center main groove on an inner side in the vehicle width direction of the pair of center main grooves is Wg2, a condition of 0.7≤Wg1/Wg2≤1.3 is satisfied.

14. The pneumatic tire according to claim 13, wherein the carcass cords have, under a load of 1.0 cN/dtex, an intermediate elongation EM satisfying a condition of EM≤5.0%.

15. The pneumatic tire according to claim 14, wherein the carcass cords have a fineness based on corrected weight CF satisfying a condition of 4000 dtex≤CF≤8000 dtex.

16. The pneumatic tire according to claim 15, wherein the carcass cords have, after dip treatment, a twist coefficient CT satisfying a condition of CT≥2000 (T/dm)×dtex^{0.5}.
